(19) United States
(12) Patent Application Publication
(10) Pub. No.: US 2004/0237045 A1
(43) Pub. Date: Nov. 25, 2004

(54) Method for asynchronous sharing of integrated spreadsheets using a network

(75) Inventor: Andrew Meltzer, Mendota Heights, MN (US)

Correspondence Address: Leffert Jay & Polglaze, P.A., P. O. Box 581009, Minneapolis, MN, 55458-1009, US

(73) Assignee: eIntelligence, Inc.

(21) Appl. No.: 10/844,854

(22) Filed: May 13, 2004

Related U.S. Application Data
(60) Provisional application No. 60/472,187, filed on May 21, 2003.

(51) Int. Cl. G06F 17/21

(52) U.S. Cl. 715/530

(57) ABSTRACT

A system and method is described for collaborative viewing, editing, and interacting in an asynchronous manner with shared data utilizing conventionally available programs, web browsers, and email. A server capable of interacting with, modifying, integrating, and exporting shared data from a data source, generates and sends a data file via email using technology such as HTML or XML. The user accesses the email and makes changes, modifications, additions, or provides navigational directions to the system based on the fields presented in the data file. When done, the user completes the session and communicates the changes or changed data file to the result server. The results of the user's work are received and integrated by the result server back into the data repository. In one embodiment, the result server then generates and sends new views of the data and latest changes to the user.

### TECHNICAL FIELD OF THE INVENTION

The present invention relates generally to data analysis, and in particular to a systems and methods for asynchronously sharing integrated editable and non-editable spreadsheets over the Internet.

### BACKGROUND OF THE INVENTION

Knowledge analysis and management is critical within today's business structures. Business users often want to view business information and key performance indicators but, since a business may have more than one data system, it can be difficult to present key performance indicators in an integrated fashion. In addition, there may be so many key performance indicators that they can be difficult to view in a single view.

To aid in this, On-line Analytical Processing (OLAP) applications were introduced to allow for dynamic analysis and viewing of data and information. However, OLAP applications typically are used to analyze and view static non-volatile, non-modifiable data and do not allow for making modifications and alterations to the underlying data.

Dynamic integrated data collaboration engines/systems have begun to enter the mainstream, extending on OLAP's basis and allowing the user to dynamically view and change data and information. However, these systems, which allow users to share their analysis and data modifications, often require complex and error-prone integration to merge the modifications and results of the collaboration. Problems arise if individual users try to enter their changes at the same time and do not enter their changes separately in a time sequential fashion after regenerating the report with the latest changes. To overcome this limitation some integrated systems require that users remain connected to the system to allow for synchronization and integration of the modifications, so that the parties may share the results of each other's analysis in a near instantaneous manner.

In collaboration systems/engines that allow off-line analysis, the user is required to download data sets, manipulate them offline with specialized applications and then manually re-upload them to an integration server. Other systems rely on the manual serial emailing of spreadsheets among groups of users, followed by a manual integration of the resulting spreadsheets into the data collaboration engine.

For the reasons stated above, and for other reasons stated below which will become apparent to those skilled in the art upon reading and understanding the present specification, there is a need in the art for alternative apparatus and methods of asynchronous and user-friendly approach to collaborative data sharing and integration of results.

### DEFINITIONS

Eimail: The invention described here.

Eimail file: The email or email attachment file that contains the data, formatting, and display information that is sent to the user.

Eimail result: The data file that is returned when the user has completed changes to the data in the eimail file.

Eimail data server: The application or suite of applications that reads the data and prepares the eimail file with it.

Eimail file presentation application: The application that presents the eimail file to the end user. This may be an application such as an email program, web browser, or any other application or combination of applications that allows a user to modify and send data.

Eimail result server: The application that receives the results of the users' modifications and integrates the changes into the data repository. This may optionally be the same application as the eimail data server.

### SUMMARY

The above-mentioned problems with asynchronous collaborative data sharing and other problems are addressed by the present invention and will be understood by reading and studying the following specification.

The various embodiments of the present invention relate to collaborative viewing, editing, and interacting asynchronously with shared data utilizing standard web browsers and email. A server capable of interacting with, modifying, and exporting data from a data source (file, database, etc.), called the data server, generates a data file (herein referred to as the eimail file) using a technology such as, but not limited to, Microsoft Excel, Microsoft Word, hypertext markup language (HTML), or extensible markup language (XML). The eimail data server then encodes and communicates this eimail file as an email message or as an email attachment to a user. Once the user receives the email, the user accesses it and makes changes, modifications, additions, or provides other navigational directions to the system based on the fields presented in the eimail file. When done, the user completes the session and communicates the eimail file or the changes to the eimail result server. In one embodiment, the application utilized to access the eimail file, the eimail file presentation application, then emails the results back to the eimail result server. In another embodiment the eimail file processor uses an alternative transport mechanism, such as hypertext transport protocol (HTTP) or file transfer protocol (FTP), to send the data to the eimail result server for processing. In another embodiment of the invention, the email may include multiple check-sums or other techniques to validate the user and other relevant data. Once the results of the user's work are received and integrated by the eimail result server into the data repository, the eimail result server, in one embodiment, may then (optionally) generate and send new views of the data for the user based on the content of the latest changes. The embodiments of the present invention require no specific email or browser implementation. Embodiments of the present invention may also be utilized with any email and browser based or enabled display technology.

For one embodiment, in a system having a data repository, a method of a plurality of users collaboratively sharing, manipulating, and integrating data asynchronously through a network comprising exporting a data file from the data repository, sending the data file to a first and second user, allowing the first and second user to asynchronously modify the data file, sending a response to a results server having one or more changes to the data file from the first user, sending a response to a results server having one or more changes to the data file from the second user, and integrating the one or more changes of the first and second user to the data repository.

For another embodiment, the invention provides a method of operating a collaboration system comprising generating a first and second data file from a data source by a collaboration engine, sending the first data file to a first user and the second data file to a second user, modifying the first and second data file off-line and/or inserting navigational directions, asynchronously returning the first and second data file to a results server, and integrating the first and second data file to the data source.

For yet another embodiment, the invention provides a system comprising a data source coupled to a collaboration engine, and a results server coupled to the data source, wherein the collaboration engine is adapted to generate a data file and send it to a user to be modified off-line and where the results server is adapted to receive the modified data file from the user and integrate it into the data source.

For a further embodiment, the invention provides a method of asynchronously modifying shared data comprising generating a plurality of data files from a data source, sending each data file of the plurality of data files to a user of a plurality of users, asynchronously receiving the plurality of data files with a results server, and asynchronously integrating the data changes in the plurality of data files to the data source.

Further embodiments of the invention include methods and apparatus of varying scope.

### BRIEF DESCRIPTION OF THE DRAWINGS

FIG. 1 is a simplified block diagram of a system in accordance with an embodiment of the present invention.

FIG. 2 is a simplified flowchart of an algorithm in accordance with an embodiment of the present invention.

FIG. 3 is a simplified user's view of an eimail file in accordance with an embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and architecture changes may be made without departing from the scope of the present invention. The following detailed description is, therefore, not to be taken in a limiting sense, and the scope of the present invention is defined only by the appended claims and equivalents thereof.

Some portions of the detailed systems and methods that follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

It is noted that software routines that incorporate methods of embodiments of the present invention can be stored on a variety of computer usable storage mediums that include, but are not limited to, a hard drive, a magnetic media tape or disk, a CD-ROM, an optical media disk, a non-volatile Flash memory, a read only memory (ROM), an electrically erasable programmable read only memory (EEPROM), a one time programmable (OTP) memory device, an application specific integrated circuit (ASIC), or any other read-write or read-only memory device.

The various embodiments of the present invention relate to collaborative viewing, editing, and interacting asynchronously with shared data utilizing standard web browsers and email. A server capable of interacting with, modifying, and exporting data from a data source (file, database, etc.), called the data server, generates a data file (herein referred to as the eimail file) using a technology such as, but not restricted to HTML or XML. The eimail data server then encodes and communicates this eimail file as an email message or as an email attachment to a user. In one HTML based embodiment, the eimail file uses “INPUT” tags to indicate where the user can edit; the data may be formatted as tables, drop-down lists, selections, or any other valid HTML input format. In an XML embodiment, the data may use any valid mechanism for the modification of the data. Once the user receives the email, the user accesses it with a presentation program and makes changes, modifications, additions, or provides other navigational directions to the system based on the fields presented in the eimail file. It is noted that many email programs (for example Microsoft Outlook) are capable of directly presenting multiple file attachment formats to a user. When done, the user completes the session and communicates the eimail file or the changes to the eimail result server. In one embodiment, the eimail file presentation application then emails the results back to the eimail result server, which parses the results and integrates them into the data repository.

In another embodiment the eimail file presentation program/processor uses an alternative transport mechanism such as HTTP or FTP to send the data to the eimail result server for processing. In another embodiment of the invention, the email may include multiple check-sums or other techniques to validate the user and other relevant data before communication. These checksums, data validation, and alternative transport mechanisms may be facilitated through programs embedded or invoked within the email file (including applets, javascript, etc.), or by the browser or email program using such facilities as “mailto:”. The programs used to process the email file, the email file presentation application (for example, but not limited to, Microsoft Word, Microsoft Excel, a web browser, or an email program), may automatically detect that the user is done, or by the selection of a button indicating completeness (such as, in one embodiment, an HTML “submit” button). Once the results of the user's work are received and integrated by the eimail result server, the eimail result server, in one embodiment, may then (optionally) generate and send new views of the data for the user based on the content of the latest changes. The embodiments of the present invention require no specific email or browser implementation. Embodiments of the present invention may also be utilized with any email and browser based or enabled display technology.

Portals and web browsers have become an effective approach for displaying information in a small number of pages. In one embodiment, the user displays the generated email file information within a portal or within some other type of page (e.g., a web page) which allows the user to dynamically manipulate them. In another embodiment, the user downloads the generated email file information from a portal or web server by use of a web browser and dynamically manipulates them off-line.

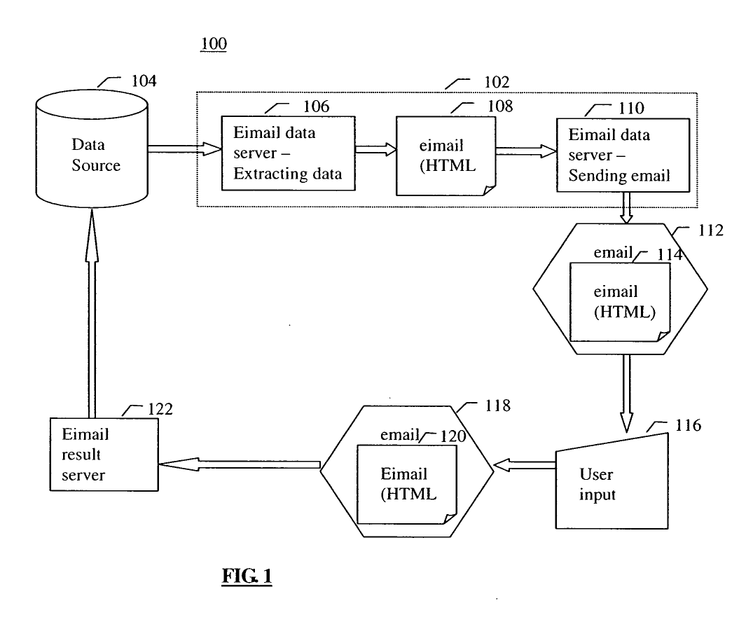

FIG. 1 details a simplified diagram of an eimail system 100 of an embodiment of the present invention. In this system, an eimail data server 102 directly, or by utilizing a decision support application 106, accesses one or more data sources 104 (such as a data warehouse) and generates a report 108. In the embodiment detailed in FIG. 1, the eimail data server 102 generates an HTML formatted report 108 from the data source(s) 104, which is modifiable through the use of HTML “INPUT” tags, however, the data may be formatted as tables, drop-down lists, selections, or any other valid HTML input format. An example of a HTML formatted eimail file is shown in Table 1. In an alternative embodiment, the eimail data server 102 creates XML report 108 that represents the data. In the XML embodiment, the data may use any valid mechanism for the modification of the data. It is noted that other user modifiable formatted report outputs of eimail reports 108, including, but not limited to, Microsoft Excel, Microsoft Word, and Microsoft Access, in alternative embodiments of the present invention are possible and should be apparent to those skilled in the art with the benefit of the present disclosure. The techniques to generate these reports are well known in the art and not described here. The techniques used to direct an application to generate HTML, XML, or other user modifiable formatted outputs are also well known in the art and not described here.

TABLE 1
Example generated email file (HTML):

```
<HTML><HEAD>
<META HTTP-equiv=“Content-Type” content=“text/HTML;charset=iso-8859-1”>
<META name=“Generator” content=“e.Intelligence”>
<TITLE>e.Intelligence HTML export</TITLE>
<STYLE type=“text/css”>
<!--
TD {font-family: Arial,Helvetica,Sans-serif;color: #000000;background-color:
      #ffffff;font-weight: normal;font-style: normal;align: right;font-size:
      10pt;}
.T0 { background-color: #b0c4de;align: left;}
.T1 { background-color: #d8e5f6;align: left;}
.T2 { }
.T3 { font-weight: bold;font-style: italic;}
.T4 { font-weight: bold;font-style: italic;}
.T5 { background-color: #ff0000;color: #ffffff;font-weight: bold;}
.T6 { background-color: #ff0000;color: #ffffff;font-weight: bold;font-style:
      italic;}
.T7 { background-color: #ff0000;color: #ffffff;font-weight: bold;font-style:
      italic;}
.T8 { background-color: #4169e1;color: #ffffff;font-weight: bold;}
.T9 { background-color: #4169e1;color: #ffffff;font-weight: bold;font-style:
      italic;}
.T10 { background-color: #4169e1;color: #ffffff;font-weight: bold;font-style:
      italic;}
.T11 { background-color: #ffa500;color: #ffffff;font-weight: bold;}
.T12 { background-color: #ffa500;color: #ffffff;font-weight: bold;font-style:
      italic;}
.T13 { background-color: #ffa500;color: #ffffff;font-weight: bold;font-style:
      italic;}
.T14 { background-color: #ffa500;color: #ffffff;font-weight: bold;}
.T15 { background-color: #ffa500;color: #ffffff;font-weight: bold;font-style:
      italic;}
.T16 { background-color: #ffa500;color: #ffffff;font-weight: bold;font-style:
      italic;}
.T17 { background-color: #e6e6e6;}
.T18 { background-color: #b0c4de;font-weight: bold;align: left;}
.T19 { background-color: #e6e6e6;font-weight: bold;}
.T20 { font-weight: bold;}
.T21 { background-color: #e6e6e6;font-weight: bold;}
.T22 { background-color: #b0c4de;font-weight: bold;align: left;}
.T23 { background-color: #e6e6e6;color: #008000;font-weight: bold;}
.T24 { background-color: #e6e6e6;color: #008000;font-weight: bold;}
.T25 { background-color: #e6e6e6;color: #800080;font-weight: bold;}
-->
</STYLE>
</HEAD>
<SCRIPT language=“JavaScript”>
<!-- Begin JavaScript
var keyCode
;function mC(cell) {cell.name=“mod”+cell.name;}
// End -->
</SCRIPT>
<P><FONT size=3>Generated by </FONT><FONT face=“Arial,Helvetica,Sans-
      serif”><A HREF=“HTTP://www.eintelligence-inc.com”>e.Intelligence,
      Inc.</A></FONT></P>
<FORM name=“eiSubmitForm” onKeyPress=‘keyCode=event.keyCode;’ onSubmit=‘if
      (keyCode==13) {keyCode=0; return false;}’ method=“POST”
      ACTION=“mailto:eimail@eintelligence-inc.com” style=“margin-bottom:0px”>
<INPUT type=“submit” name=“submit” value=“Submit Changes”><BR><BR>
<INPUT type=“hidden” name=“eiMailHandler” value=“eimail@eintelligence-
      inc.com”>
<INPUT type=“hidden” name=“eiBinDir”
      value=“/home/ameltzer/60/server/bin/lnks”>
<INPUT type=“hidden” name=“eiCheckSum” value=“1979436825”>
<INPUT type=“hidden” name=“eiUserAddress” value=“ameltzer@eintelligence-
      inc.com”>
<INPUT type=“hidden” name=“eiUserName” value=“ameltzer”>
<INPUT type=“hidden” name=“eiReportName”
      value=“/home/username/directory/week_rpt.mlo.wfv”>
<BODY bgColor=“#ffffff”>
<TABLE cellSpacing=0 cellPadding=0 align=“left” bgColor=“#ffffff” border=1>
<TBODY>
<TR><TD nowrap class=“T0”>&nbsp;</TD>
<TD nowrap class=“T0”>&nbsp;</TD>
<TD nowrap class=“T0”>&nbsp;</TD>
<TD nowrap class=“T0”>W13 2003</TD>
<TD nowrap class=“T0”>SEP 2002</TD>
<TD nowrap class=“T0”>W14 2003</TD>
<TD nowrap class=“T0”>W15 2003</TD>
<TD nowrap class=“T0”>W16 2003</TD>
<TD nowrap class=“T18”>W17 2003</TD>
<TD nowrap class=“T0”>OCT 2002</TD>
<TD nowrap class=“T0”>W18 2003</TD>
<TD nowrap class=“T0”>W19 2003</TD>
<TD nowrap class=“T0”>W20 2003</TD>
<TD nowrap class=“T18”>W21 2003</TD>
<TD nowrap class=“T0”>NOV 2002</TD>
<TD nowrap class=“T0”>W22 2003</TD>
</TR>
<TR><TD nowrap class=“T0”>GLOBAL</TD>
<TD nowrap class=“T0”>ALL PRODUCTS</TD>
<TD nowrap class=“T0”>Ship Qty</TD>
<TD class=“T17”>N/A</TD>
<TD class=“T21”>4,350,293</TD>
<TD class=“T17”>N/A</TD>
<TD class=“T17”>N/A</TD>
<TD class=“T17”>N/A</TD>
<TD class=“T17”>N/A</TD>
<TD class=“T21”>N/A</TD>
<TD class=“T17”>N/A</TD>
<TD class=“T17”>N/A</TD>
<TD class=“T17”>N/A</TD>
<TD class=“T17”>N/A</TD>
<TD class=“T21”>N/A</TD>
<TD class=“T17”>N/A</TD>
</TR>
<TR><TD nowrap class=“T0”>&nbsp;</TD>
<TD nowrap class=“T0”>&nbsp;</TD>
<TD nowrap class=“T0”>Committed Fcst Qty</TD>
<TD class=“T17”>2,011,113</TD>
<TD class=“T21”>4,856,146</TD>
<TD class=“T17”>1,168,470</TD>
<TD class=“T17”>1,063,901</TD>
<TD class=“T17”>1,051,906</TD>
<TD class=“T17”>1,880,639</TD>
<TD class=“T21”>5,164,916</TD>
<TD class=“T17”>1,034,010</TD>
<TD class=“T17”>1,041,030</TD>
<TD class=“T17”>1,018,332</TD>
<TD class=“T17”>2,151,289</TD>
<TD class=“T21”>5,244,661</TD>
<TD class=“T17”>944,347</TD>
</TR>
<TR><TD nowrap class=“T0”>&nbsp;</TD>
<TD nowrap class=“T0”>&nbsp; </TD>
<TD nowrap class=“T0”>Revenue Plan Fcst Qty</TD>
<TD class=“T17”>2,119,416</TD>
<TD class=“T21”>5,547,495</TD>
<TD class=“T17”>1,097,236</TD>
<TD class=“T17”>1,092,947</TD>
<TD class=“T17”>1,094,950</TD>
<TD class=“T17”>1,935,819</TD>
<TD class=“T21”>5,220,952</TD>
<TD class=“T17”>1,080,583</TD>
<TD class=“T17”>1,073,681</TD>
<TD class=“T17”>1,074,548</TD>
<TD class=“T17”>2,218,364</TD>
<TD class=“T21”>5,447,176</TD>
<TD class=“T17”>1,002,546</TD>
</TR>
<TR><TD nowrap class=“T0”>&nbsp;</TD>
<TD nowrap class=“T0”>&nbsp;</TD>
<TD nowrap class=“T0”>Statistical Fcst</TD>
<TD class=“T17”>1,302,865</TD>
<TD class=“T21”>5,653,158</TD>
<TD class=“T17”>1,014,147</TD>
<TD class=“T17”>1,089,988</TD>
<TD class=“T17”>1,035,467</TD>
<TD class=“T17”>1,173,630</TD>
<TD class=“T21”>4,313,232</TD>
<TD class=“T17”>1,119,837</TD>
<TD class=“T17”>1,062,160</TD>
<TD class=“T17”>1,117,049</TD>
<TD class=“T17”>1,090,331</TD>
<TD class=“T21”>4,389,377</TD>
<TD class=“T17”>1,001,263</TD>
</TR>
<TR><TD nowrap class=“T0”>&nbsp;</TD>
<TD nowrap class=“T0”>&nbsp;</TD>
<TD nowrap class=“T0”>Acct Manager Fcst Qty</TD>
<TD><INPUT class=“T2” type=“text” onChange=‘mC(this)’ size=“12” name=“c_5_3”
      value=“1,302, 865”></TD>
<TD><INPUT class=“T20” type=“text” onChange=‘mC(this)’ size=“12” name=“c_5_4”
      value=“4,807,747”></TD>
<TD><INPUT class=“T2” type=“text” onChange=‘mC(this)’ size=“12” name=“c_5_5”
      value=“1,014,147”></TD>
<TD><INPUT class=“T2” type=“text” onChange=‘mC(this)’ size=“12” name=“c_5_6”
      value=“1,089,988”></TD>
<TD><INPUT class=“T2” type=“text” onChange=‘mC(this)’ size=“12” name=“c_5_7”
      value=“1,035,467”></TD>
<TD><INPUT class=“T2” type=“text” onChange=‘mC(this)’ size=“12” name=“c_5_8”
      value=“1,173,630”></TD>
<TD><INPUT class=“T20” type=“text” onChange=‘mC(this)’ size=“12” name=“c_5_9”
      value=“4,313,232”></TD>
<TD><INPUT class=“T2” type=“text” onChange=‘mC(this)’ size=“12” name=“c_5_10”
      value=“1,119,837”></TD>
<TD><INPUT class=“T2” type=“text” onChange=‘mC(this)’ size=“12” name=“c_5_11”
      value=“1,062,160”></TD>
<TD><INPUT class=“T2” type=“text” onChange=‘mC(this)’ size=“12” name=“c_5_12”
      value=“1,117,049”></TD>
<TD><INPUT class=“T2” type=“text” onChange=‘mC(this)’ size=“12” name=“c_5_13”
      value=“1,090,331”></TD>
<TD><INPUT class=“T20” type=“text” onChange=‘mC(this)’ size=“12”
      name=“c_5_14” value=“4,389,377”></TD>
<TD><INPUT class=“T2” type=“text” onChange=‘mC(this)’ size=“12” name=“c_5_15”
      value=“1,001,263”></TD>
</TR>
<TR><TD nowrap class=“T0”>&nbsp;</TD>
<TD nowrap class=“T0”>&nbsp;</TD>
<TD nowrap class=“T0”>Revenue Plan Fcst Qty A</TD>
<TD><INPUT class=“T2” type=“text” onChange=‘mC(this)’ size=“12” name=“c_6_3”
      value=“1,302,865”></TD>
<TD><INPUT class=“T20” type=“text” onChange=‘mC(this)’ size=“12” name=“c_6_4”
      value=“4,807,747”></TD>
<TD><INPUT class=“T2” type=“text” onChange=‘mC(this)’ size=“12” name=“c_6_5”
      value=“1,014,147”></TD>
<TD><INPUT class=“T2” type=“text” onChange=‘mC(this)’ size=“12” name=“c_6_6”
      value=“1,089,988”></TD>
<TD><INPUT class=“T2” type=“text” onChange=‘mC(this)’ size=“12” name=“c_6_7”
      value=“1,035,467”></TD>
<TD><INPUT class=“T2” type=“text” onChange=‘mC(this)’ size=“12” name=“c_6_8”
      value=“1,173,630”></TD>
<TD><INPUT class=“T20” type=“text” onChange=‘mC(this)’ size=“12” name=“c_6_9”
      value=“4,313,232”></TD>
<TD><INPUT class=“T2” type=“text” onChange=‘mC(this)’ size=“12” name=“c_6_10”
      value=“1,119,837”></TD>
<TD><INPUT class=“T2” type=“text” onChange=‘mC(this)’ size=“12” name=“c_6_11”
      value=“1,062,160”></TD>
<TD><INPUT class=“T2” type=“text” onChange=‘mC(this)’ size=“12” name=“c_6_12”
      value=“1,117,049”></TD>
<TD><INPUT class=“T2” type=“text” onChange=‘mC(this)’ size=“12” name=“c_6_13”
      value=“1,090,331”></TD>
<TD><INPUT class=“T20” type=“text” onChange=‘mC(this)’ size=“12”
      name=“c_6_14” value=“4,389,377”></TD>
<TD><INPUT class=“T2” type=“text” onChange=‘mC(this)’ size=“12” name=“c_6_15”
      value=“1,001,263”></TD>
</TR>
</TBODY></TABLE></FORM></BODY></HTML>
```

Once the report 108 is generated, the eimail server 102 directly or utilizing a separate email program or server 110 encapsulates the eimail file 108 into an email 112. The email 112, with its payload of the modifiable report 114, is then sent by the eimail server 102 to the user 116. There are many well-known techniques to encapsulate the formatted report 108 into an email (for example, the eimail file can be packaged as an email attachment or be the body of actual email) and should be apparent to those skilled in the art with the benefit of the present disclosure. It is also noted that the functions of the eimail data server may be executed on separate computer systems that are in communication with each other and is not restricted to a single machine.

The user 116 opens the email as if it were any other and modifies the data asynchronously (in an off-line manner, possibly separated from the network and eimail server 102). There are many possible eimail file 114 presentation applications that can be used to modify the data of the eimail file 114. Examples of these presentation applications include, but are not limited to, Microsoft Outlook, Netscape Navigator, Opera, Internet Explorer, Microsoft Word, or Microsoft Excel. When complete, the modified eimail data file or just the modifications are queued up and sent with the user's outbound email 118 to the eimail result server 122 (which may be the same system as the eimail server 102) for processing. The email 118 is sent to an address supplied with the incoming email 122 to the eimail file presentation application, typically on or associated with the eimail result server 122. The email file presentation application (for example, a web browser or email program), may automatically detect that the user is done, or detect that the user is done by the selection of a button indicating completeness (for example, an HTML “submit” button as utilized the eimail HTML of Table 1). In another embodiment the eimail file presentation application uses an alternative transport mechanism such as HTTP or FTP to send the data to the eimail result server 122 for processing. These alternative transport mechanisms may be facilitated through programs embedded or invoked within the email file (including applets, javascript, etc.), or by the browser or email program using such facilities as “mailto:”. In another embodiment of the invention, the email may include multiple check-sums or other techniques to validate the permissions of the user, input data, and other relevant parameters during eimail file modification or before sending to the eimail result server 122. These checksums, data validation, may also be facilitated through programs embedded or invoked within the email file (including applets, javascript, etc.).

At the eimail result server 122, the email 118 containing the modified eimail file 120 is read by an email processing application (such as, but not limited to, procmail or Microsoft Exchange), which determines whether the email 118 should be processed as eimail. When the email processing application identifies the incoming email 118 as a message containing data or directions for the eimail result server 122 (for example, by header information of the email 118 or by the address it is sent to), it invokes the eimail result server 122. The eimail result server 122 processes the email 118, incorporating the results and modified data of the modified eimail file 120 into the shared data repository (the data source 104), and completing any other associated tasks, such as generating different views of the system on request of the user 116 to be sent back to them. It may also, optionally, check to ensure that it is a properly formatted email 118 with proper content coming from a proper sender/user 116 with proper security and permissions. The eimail result server 122 may also utilize the eimail data server 102 to process and send a new view to the user 116 based on the user changes and incorporating the current state of the data in the data source 104. The changes may be modifications to the data, data navigational directions (such as “drill-down” to focus the view on a selected data view or arrangement), or requests for different data.

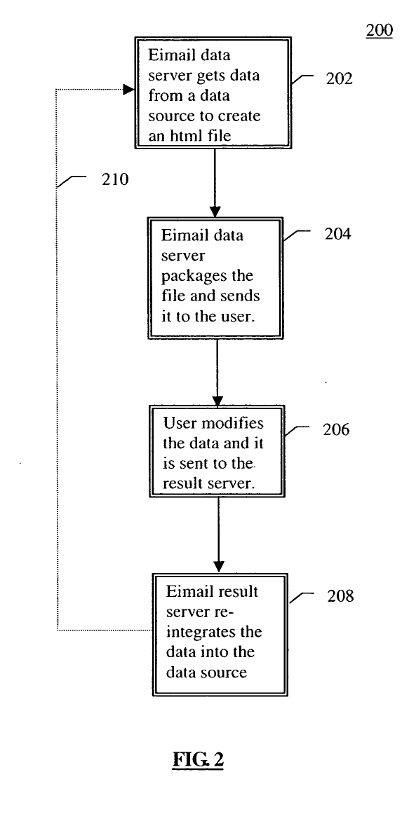

FIG. 2 shows a simplified flowchart 200 of a method of operating an eimail collaboration engine/system in accordance with an embodiment of the present invention. In FIG. 2, an eimail collaboration server gets data from a data source 202 to generate an HTML based eimail file. The eimail server then incorporates the eimail file into an email and sends it to a user 204. The email is opened and the eimail data file is modified offline by the user using a presentation application. After the user is done modifying the data of the eimail file, the user completes the file and sends it to the eimail results server 206. The eimail results server processes the returned email and modified eimail data file, re-integrating the modified data into the data source 208. The eimail result server may optionally then generate and send a new eimail data file/email to the user 210.

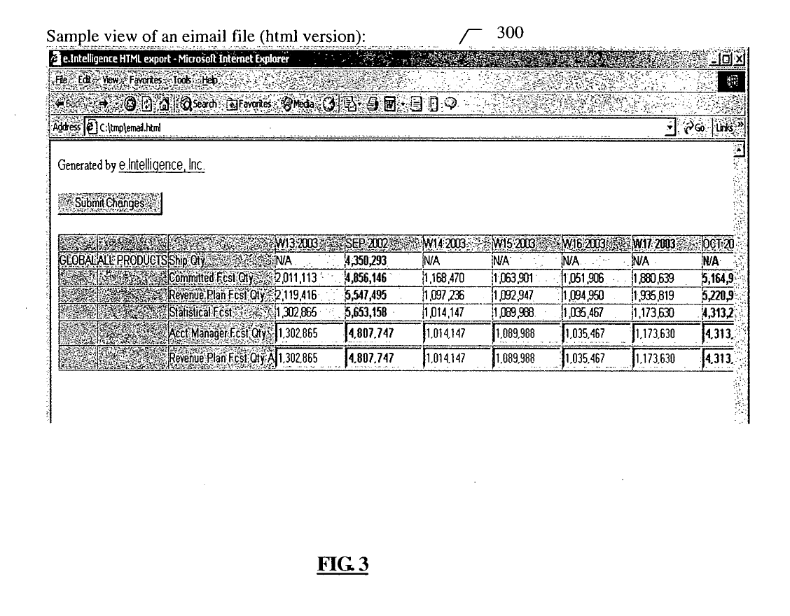

FIG. 3 shows an example view 300 of an HTML eimail data file of an embodiment of the present invention as displayed by a web browser for user interaction and modification. In FIG. 3, the eimail data file is presented in table format by the browser. Data that is not modifiable by the user is presented as text in table fields, while data that is modifiable by the user is presented in input fields in the table. A “submit changes” button submits the user inputs to the eimail results server when clicked on by the user.

In the above discussion, the term “computer” is defined to include any digital or analog data processing unit. Examples include any personal computer, workstation, set top box, mainframe, server, supercomputer, laptop or personal digital assistant capable of embodying the inventions described herein.

In one embodiment, the application is stored as instructions on a computer usable medium. The instructions, when executed on one or more computers, create a system 100 for executing the method as shown in FIG. 1.

It is noted that collaborative viewing, editing, and interacting asynchronously with shared data with other embodiments of the present invention are possible and should be apparent to those skilled in the art with the benefit of the present invention.

### CONCLUSION

A system and method has been described that allows for collaborative viewing, editing, and interacting asynchronously with shared data utilizing standard web browsers and email. A server capable of interacting with, modifying, and exporting data from a data source (file, database, etc.), called the data server, generates a data file (herein referred to as the eimail file) using a technology such as, but not restricted to HTML or XML. The eimail data server then encodes and communicates this eimail file as an email message or as an email attachment to a user. In its HTML embodiment for example, the eimail file uses “INPUT” tags to indicate where the user can edit; the data may be formatted as tables, drop-down lists, selections, or any other valid HTML input format. In the XML embodiment, the data may use any valid mechanism for the modification of the data. Once the user receives the email, the user accesses it and makes changes, modifications, additions, or provides other navigational directions to the system based on the fields presented in the eimail file. Email programs (for example Microsoft Outlook) are capable of presenting many attachments formats to a user. When done, the user completes the session and communicates the eimail file or the changes to the eimail result server. In one embodiment, the eimail file presentation application then emails the results back to the eimail result server, which parses the results and integrates them into the data repository. In another embodiment the eimail file processor uses an alternative transport mechanism such as HTTP or FTP to send the data to the eimail result server for processing. In another embodiment of the invention, the email may include multiple check-sums or other techniques to validate the user and other relevant data before communication. These checksums, data validation, and alternative transport mechanisms may be facilitated through programs embedded or invoked within the email file (including applets, javascript, etc.), or by the browser or email program using such facilities as “mailto:”. The programs used to process the email file, the email file presentation application (for example, a web browser or email program), may automatically detect that the user is done, or by the selection of a button indicating completeness (such as, in one embodiment, an HTML “submit” button). Once the results of the user's work are received and integrated by the eimail result server, the eimail result server, in one embodiment, may then (optionally) generate new views of the data for the user based on the content of the latest changes. The embodiments of the present invention require no specific email or browser implementation. Embodiments of the present invention may also be utilized with any email and browser based or enabled display technology.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A method of a plurality of users collaboratively sharing, manipulating, and integrating data asynchronously through a network, comprising:
exporting a data file from the data repository;
sending the data file to a first and second user;
allowing the first and second user to asynchronously modify the data file;
sending a response to a results server having one or more changes to the data file from the first user;
sending a response to a results server having one or more changes to the data file from the second user; and
integrating the one or more changes of the first and second user to the data repository.

2. The method of claim 1, wherein the data file is modified off-line.

3. The method of claim 1, wherein sending the data file to a first and second user further comprises encapsulating the data file in an email and sending the email to a first and second user.

4. The method of claim 3, wherein encapsulating the data file further comprises attaching the data file to the email.

5. The method of claim 3, wherein encapsulating the data file further comprises incorporating the data file into the body of the email.

6. The method of claim 1, further comprising:
generating and sending a new data file to the first or second user upon receiving a response based on the updated data in the data repository.

7. The method of claim 1, further comprising:
generating and sending a new data file to the first or second user based on data navigation instructions the response form the first or second user.

8. The method of claim 1, wherein sending a response to a results server having one or more changes to the data file from the first or second user further comprises executing one or more programs embedded in the data file.

9. The method of claim 8, wherein executing one or more embedded programs further comprises evaluating one of a checksum, a user permission check, a valid data check, a data range check, and a data security check.

10. The method of claim 1, wherein exporting a data file from the data repository further comprises exporting a data file in one of XML, HTML, Microsoft Excel, and Microsoft Word format.

11. The method of claim 1, wherein sending a response to a results server having one or more changes to the data file from the first or second user further comprises sending changes via one of email, HTTP, and FTP.

12. The method of claim 1, further comprising:
presenting the data file to the first or second user with a presentation application, wherein the presentation application is one of a web browser, an email program, a spreadsheet application, and a word processor.

13. The method of claim 1, wherein allowing the first and second user to asynchronously modify the data file further comprises allowing the user to insert navigational directions to the data file.

14. A method of operating a collaboration system, comprising:
generating a first and second data file from a data source by a collaboration engine;
sending the first data file to a first user and the second data file to a second user;
modifying the first and second data file off-line and/or inserting navigational directions;
asynchronously returning the first and second data file to a results server; and
integrating the first and second data file to the data source.

15. The method of claim 14, wherein sending the first and second data files to a first and second user further comprises downloading the first and second data files from one of a web server and a portal.

16. The method of claim 14, wherein sending the first and second data files to a first and second user further comprises encapsulating the first and second data files in a first and second email and sending the first and second emails to the first and second users.

17. The method of claim 14, further comprising:
generating and sending a new data file to the first or second user upon the return of the first or second data file based on the latest data in the data source.

18. The method of claim 14, wherein modifying the first or second data file off-line and/or inserting navigational directions further comprises executing one or more programs or scripts embedded in the first or second data file.

19. The method of claim 18, wherein executing one or more embedded programs or scripts further comprises evaluating one of a checksum, a user permission check, a valid data check, a data range check, and a data security check.

20. The method of claim 14, wherein returning the first and second data file to a results server further comprises sending only modified data of the first and second data file to the results server.

21. A system, comprising:
a data source coupled to a collaboration engine; and
a results server coupled to the data source, wherein the collaboration engine is adapted to generate a data file and send it to a first and second user to be modified off-line and where the results server is adapted to asynchronously receive the modified data file from the first and second user and integrate it back into the data source.

22. The system of claim 21, wherein the collaboration engine is adapted to send the data file to the first and second user by encapsulating the data file in an email.

23. The system of claim 21, wherein the generated data file includes one or more programs or scripts embedded in the data file.

24. The system of claim 21, wherein the results server is adapted to generate and send a new data file to the first or second user based on user input in the modified data file and the latest data in the data source.

25. A computer-usable medium, the computer-usable medium containing a software routine for causing a processor to execute a method, wherein the method comprises:
generating a data file from a data source by a collaboration engine;
sending the data file to a first and second user;
modifying the data file off-line and/or inserting navigational directions;
asynchronously returning the data file to a results server from the first and second users; and
integrating the modifications from the data file of the first and second user into the data source.

26. A method of asynchronously modifying shared data, comprising:
generating a plurality of data files from a data source;
sending each data file of the plurality of data files to a user of a plurality of users;
asynchronously receiving the plurality of data files with a results server; and
asynchronously integrating the data changes in the plurality of data files to the data source.

27. The method of claim 26, wherein sending each data file of the plurality of data files to a user of a plurality of users further comprises encapsulating each data file of the plurality of data files in an email and sending each email to a user of the plurality of users.

28. The method of claim 26, further comprising:
generating and sending a new data file to a user of the plurality of users upon the return of the data file utilizing the updated data in the data source.

29. The method of claim 26, further comprising:
modifying the data contained in each data file of the plurality of data files and/or inserting data navigational directions.

30. The method of claim 26, wherein modifying the data contained in each data file of the plurality of data files and/or inserting data navigational directions further comprises executing one or more programs or scripts embedded in the data file.

31. The method of claim 30, wherein executing one or more embedded programs or scripts further comprises evaluating one of a checksum, a user permission check, a valid data check, a data range check, and a data security check.

32. The method of claim 26, wherein asynchronously returning the plurality of data files to a results server further comprises sending only modified data of the plurality of data files to the results server.

33. The method of claim 26, wherein asynchronously integrating the data changes in the plurality of data files to the data source further comprises integrating data changes by one of a priority of change, a last change made, a data average, a data mean, a weighted average, a specified data change function, and a user ranking.

34. A method of asynchronously modifying shared data in a collaboration system, comprising:
generating a plurality of data files from a data source of a collaboration system and encapsulating each data file in an email;
sending each email to a user of a plurality of users;
asynchronously modifying the data contained in the data file of each email and/or giving data navigational directions;
asynchronously returning the plurality of data files to a results server; and
asynchronously integrating the plurality of data files to the data source.

35. The method of claim 34, further comprising:
generating and sending a new data file to a user of the plurality of users upon the return of the data file utilizing the updated data in the data source.

36. The method of claim 34, further comprising:
executing one or more embedded programs or scripts that evaluate one of a checksum, a user permission check, a valid data check, a data range check, and a data security check.

37. The method of claim 34, wherein asynchronously returning the plurality of data files to a results server further comprises sending only modified data of the plurality of data files to the results server.
